(19) United States
(12) Patent Application Publication
(10) Pub. No.: US 2008/0191446 A1
(43) Pub. Date: Aug. 14, 2008

(54) Transformable baby rider

(76) Inventor: Nelson Man Chow, New Territories (CN)

Correspondence Address: ALIX YALE & RISTAS LLP, 750 MAIN STREET, SUITE 1400, HARTFORD, CT, 06103, US

(21) Appl. No.: 11/706,827

(22) Filed: Feb. 12, 2007

(51) Int. Cl. B62M 1/00

(52) U.S. Cl. 280/263

(57) ABSTRACT

A transformable baby rider which can be transformed from baby rider to a toy mower in order to help a child to learn walking. As a child reaches 1 year of age, he or she can start to learn walking by the baby rider mode. When the child grows up, the rider mode can be transformed into the toy mower mode. In doing so, the child can hold the handlebar and begin to learn independent walking.

### FIELD OF TECHNOLOGY

This invention relates to hand-propelled vehicles, and particularly relates to carriages for children which convert into a children's toy.

### BACKGROUND OF THE INVENTION

Children can be grouped by ages. In this application, children generally refers to little boys and/or little girls preferably of the age group from 1 year old to 3 years old. Children usually begin to learn walking from 1 year of age, then graduate from such learning at 3 years of age. A baby rider is one of the popular tools adapted to help children to learn walking in the very beginning. A child rides on the baby rider and grasping the handlebar by two hands. When any of his feet abut the ground, the vehicle (the baby rider) is then pushed forward by the handlebar. In doing so, the child begins to learn walking. However, riding on such vehicle will tend to limit the child to further learn independent walking. Therefore, there must be a new tool for helping the child to upgrade his learning.

Nowadays, many kinds of tools have been used to help children for independent walking. A belt around a child's breast with a handle on the back is the most simple and widely used tool. In doing so, when the child is walking, he is absolutely independent and without any support, but when he falls, the belt (or leash) will then support him. Another tool called a baby walker is a round fence with casters, the baby (little child) can sit on the belt seat which is suspended on the round fence. When he stands up, he can independently walk without any support. But when he is exhausted, he can sit down on the seat. Strictly speaking, both the leash and the baby walker do not necessarily help a child to learn independent walking, they only play a safety role for preventing the child from falling down.

It is conventional knowledge that if a child is always riding on a baby rider, he will likely never learn independent walking. A growing child will quickly lose interest on a common baby rider. This is a shortcoming of all prior art baby riders. Therefore for many years, there has been a desire to have an up-graded baby rider which not only helps children learn walking in a first stage, but also helps children to learn independent walking in a successive stage.

An object is to provide a baby rider which has the function of a common baby rider for helping children in their first stage learning of walking. When the children grow up, the baby rider of this invention can be transformed easily and quickly (say, in a matter of seconds) to a toy which can help the children to learn independent walking. Furthermore, the baby rider may continue to catch the attention of the children until they come into the next age group, say, 4-6 years of age.

### SUMMARY

The baby rider preferably comprises a main body including 4 wheels, a hood and motor cover and a seat with a handlebar. The hood and motor cover is pivoted at the middle of the main body. The seat is pivoted at the rear of the main body and the handlebar is pivoted at the front of the seat. For transforming the baby rider to a toy mower, the seat with its handlebar can be turned upwardly into a position which is simulating the grass collector of a mower. The handlebar can be turned into a position which is parallel to the seat. Then the hood and motor cover can be turned into the vacant space which formerly occupied by the seat for simulating the engine cover of a mower. After such transformation, a child can hold the handlebar and push the toy mower forward for practicing independent walking.

### BRIEF DESCRIPTION OF THE DRAWINGS

FIG. 1 is a perspective view of a transformable baby rider.

FIG. 2 is a side elevational view of the baby rider of FIG. 1.

FIG. 3 is a front elevational view of the baby rider of FIG. 1.

FIG. 4 is a top elevational view of the baby rider of FIG. 1.

FIG. 5 is a perspective view of a toy mower which is transformed from the baby rider of FIG. 1.

FIG. 6 is a side elevational view of the toy mower of FIG. 5.

FIG. 7 is a front elevational view of the toy mower of FIG. 5.

FIG. 8 is a top plan view of the toy mower of FIG. 5.

FIG. 9 is a sectional view, partly in schematic, illustrating construction of a handle lock pivot (P3) of FIG. 5.

FIG. 10 is an exemplification for construction of the locking mechanism for a seat about (P2) of FIG. 5.

FIG. 11 is a fragmentary side view of an additional safety mechanism for the locking mechanism of FIG. 10.

FIG. 12 is a circuit diagram for a representative sounder for the transformable baby rider.

### DETAILED DESCRIPTION OF THE PREFERRED EMBODIMENTS

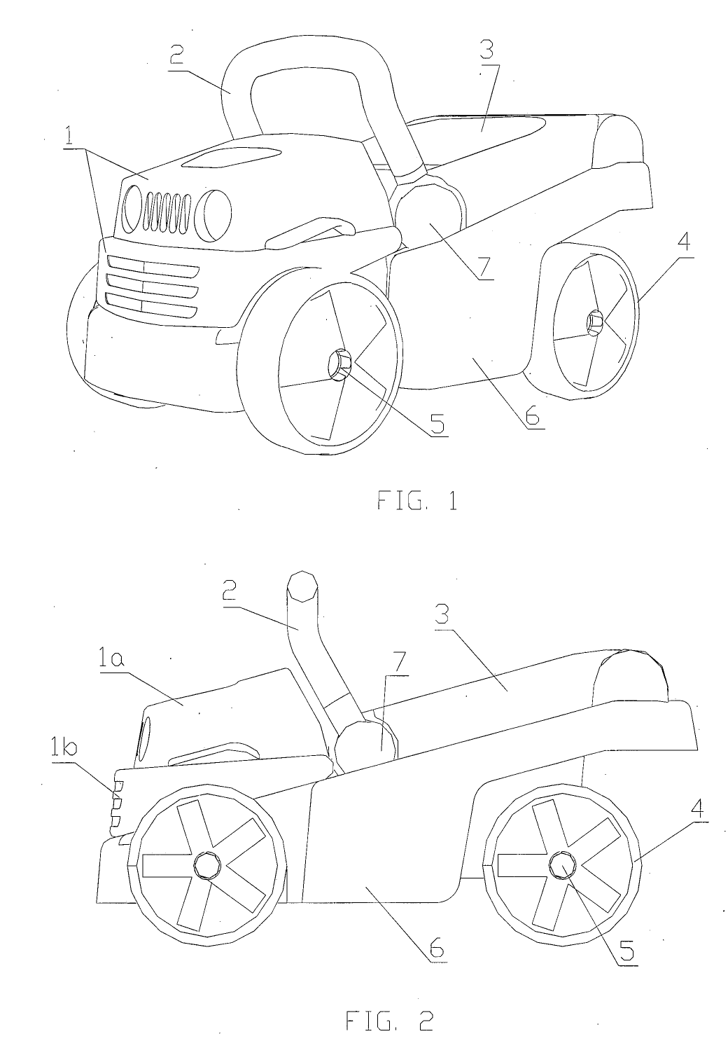

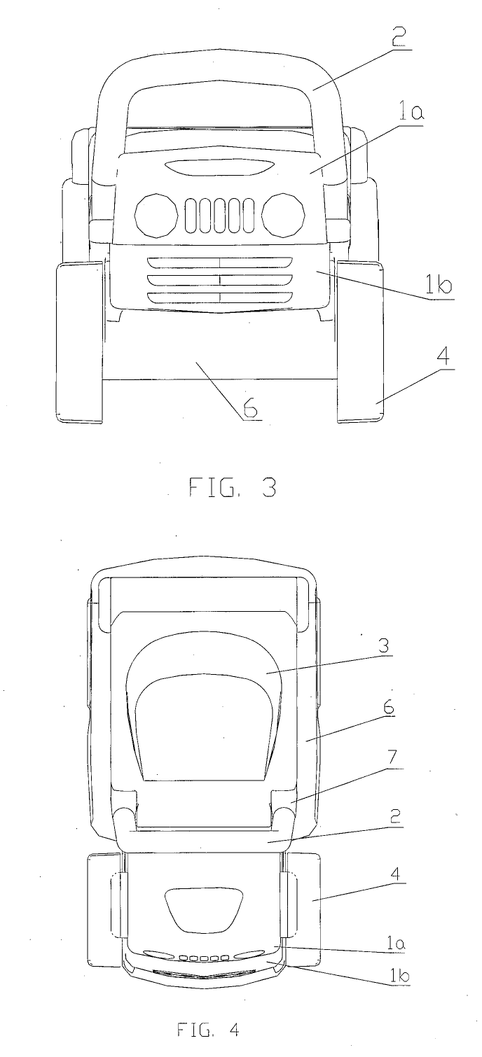

FIG. 1 is a perspective view of a baby rider. It has a similar appearance as a prior art baby rider and also functions as any prior art baby rider. With additional reference to FIG. 2, FIG. 3 and FIG. 4 (the side, front and top view of FIG. 1), the baby rider comprises a main body 6 including four wheels 4, a seat 3 with handlebar 2, a hood and motor cover 1. A baby (little child, not shown in all drawings) can ride on seat 3 with both feet touching on the ground, and both hands holding the handlebar 2. When any of the feet abut the ground, the two hands can push the handlebar 2 to move forwardly. The vehicle (baby rider) is thus propelled.

The hood 1a and the motor cover 1b can be made integrally or separately manufactured and then connected into one piece. A pair of handle lock pivots 7 being any of several prior art methods for providing two (or more) locking positions for a handlebar 2. Similar means also used for keeping seat 3 and hood and motor cover 1 in their different positions. In this baby rider mode, the handlebar 2 is locked in a position which is perpendicular to the seat 3. Four wheel hubs 5 are preferably used for preventing someone from accessing wheel screws (not shown) and to provide an appropriate aesthetic effect.

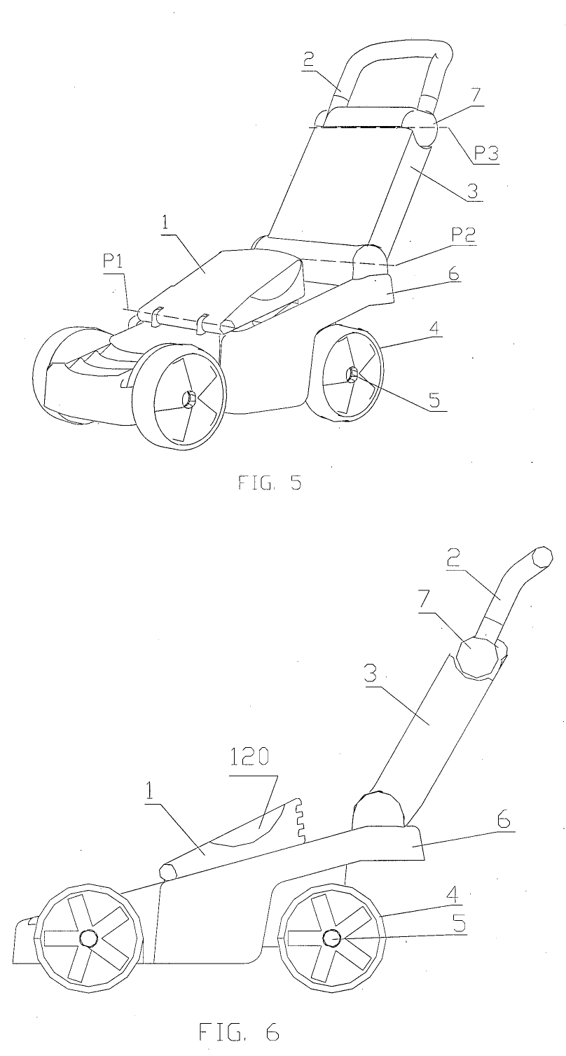

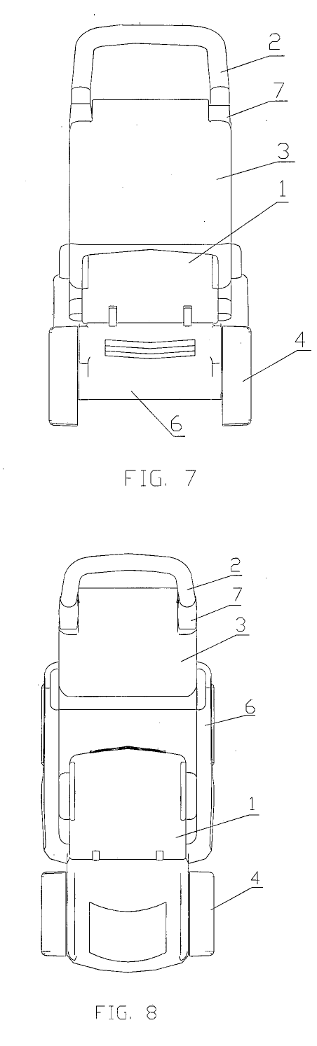

With reference FIG. 5, a toy mower is transformed from the baby rider of FIG. 1. With additional reference to FIG. 6, FIG. 7 and FIG. 8 (the side, front and top view of FIG. 5), it will be apparent that all parts of FIGS. 5, 6, 7 and 8 are the same parts used in FIGS. 1, 2, 3 and 4. The hood and motor cover 1 is pivoted on the middle of the main body 6 around pivot axis P1. The seat 3 is pivoted at the rear of the main body 6 around pivot axis P2, and the handlebar 2 is pivoted on the front of the seat 3 around pivot axis P3. In this toy mower mode, the handlebar 2 has been turned parallel to the seat 3 and self-locked in position. Therefore, in order to transform this toy mower into a baby rider, the hood and motor cover 1 should be turned counter-clockwise (as shown in FIG. 5) around the pivot axis P1 until the hood and motor cover 1 are transformed to the position shown in FIG. 1. Then, the handlebar 2 should be turned clockwise (as shown in FIG. 5) around the pivot axis P3 to make it perpendicular to the seat 3 as shown in FIG. 1. Finally, the seat 3 should be turned counter-clockwise (as shown in FIG. 5) around the pivot axis P2 until it transforms into the position shown in FIG. 1. When transforming from the baby rider mode into the toy mower mode, the above-mentioned steps are reversed.

No matter whether this invention is in its baby rider mode or in its toy mower mode, additional accessories can be added for enhancing aesthetic effects. For example, in the baby rider mode, headlights, sounder (for simulating the sound of a motor), etc. can be added. In the toy mower mode, the same sounder can also be added.

In the toy mower mode, the child can learn independent walking with his hand/hands holding the handlebar 2. When he is tired, the toy mower can be transformed into the baby rider mode in few seconds for taking a rest. Thus, the product can provide two different modes to a child throughout the ages of approximately 1-year-old to 3 years old. Therefore, the product may not only save the money, but also economize on the space for storing toys.

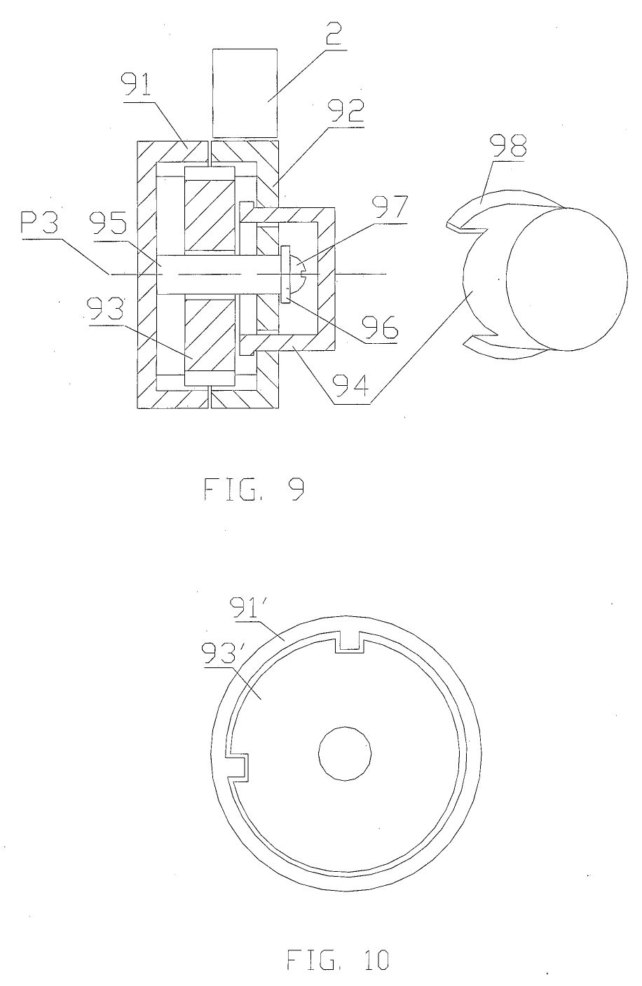

FIG. 9 is a sectional drawing of handle lock pivot 7. The center line P3 is the axis around which the handle 2 pivots. The handle lock pivot 7 comprises an inner gear 91, an inner gear 92 and a pinion 93 meshing with both inner gear 91 and inner gear 92. So in FIG. 9, three gears 91, 92 and 93 are in an engaged meshed condition. That is, there is no relative movement between gear 91 and gear 92. If the pinion 93 is pushed by button 94 to the left, the pinion 93 disengages from the inner gear 92, so the inner gear 92 can rotate freely. The handle 2 connected the inner gear 92 can be rotated to any intended position. Then, the button 94 is relieved. This will cause the pinion to return to its original position, that is, to mesh both gear 91 and 92 and once again rotatably lock them. In normal use, there are two buttons 94 that should be pressed simultaneously. Any young child cannot do this operation; this operation only can be done by a big child or an adult.

In FIG. 9, two springs (one pushing the pinion to the right and one pushing the button to right) are not shown. 95 is a stud integral to the inner gear 91. Stud 95 is used to keep inner gear 92 in position. Washer 96 and screw 97 are used for retaining the inner gear 92 on the stud 95. The button 94 has two split legs as can be seen in its perspective view. The legs are pressed inwardly and inserted into matched slots of inner gear 92. Since the legs expand outwardly when the pressure is released, the rim 98 of the legs then abut the edge of the slot and can not be push out by the spring.

In this embodiment, since the number of teeth of any gear is usually over one dozen, the user can set the handle 2 at almost any intended angle. That is, the adjustment is almost continuous.

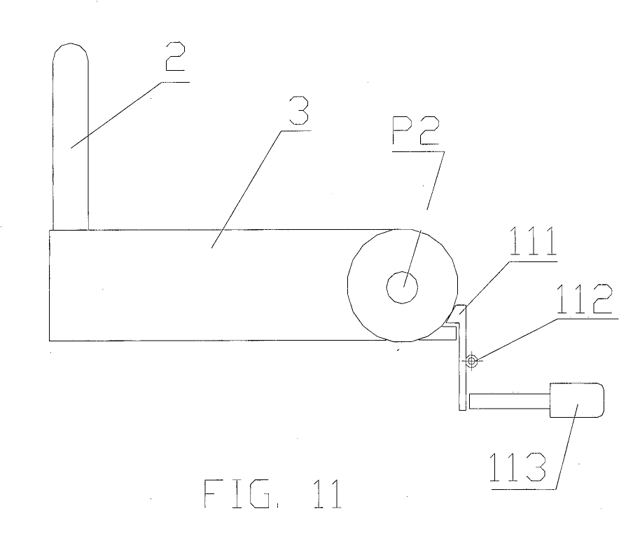

The embodiment of FIG. 10 is for pivot axis P2. All parts are similar to FIG. 9 except two inner gears 91 and 92 are replaced by two inner rimmed cups 91′ and 92′ and pinion 93 is replaced by slotted circular plate 93′. Use of the rim and the slot for replacing the gear teeth simplifies the construction greatly. Therefore, the cost will be less than that for the embodiment in FIG. 9.

In FIG. 10, this construction is used for seat 3. The loading of seat 3 is much heavier than the handle 2. Therefore, it is better to use an additional safety means to keep the seat 3 in its seating position. Therefore, FIG. 11 shows a metal strip 111 with hook head on the top, and a pivot 112 on the middle. There is a push button 113 located on the lower back portion of the body 6. Once the button 113 is pushed, the metal strip 111 will rotate around the pivot 112 and cause the hook head of the strip 111 to release the seat 3.

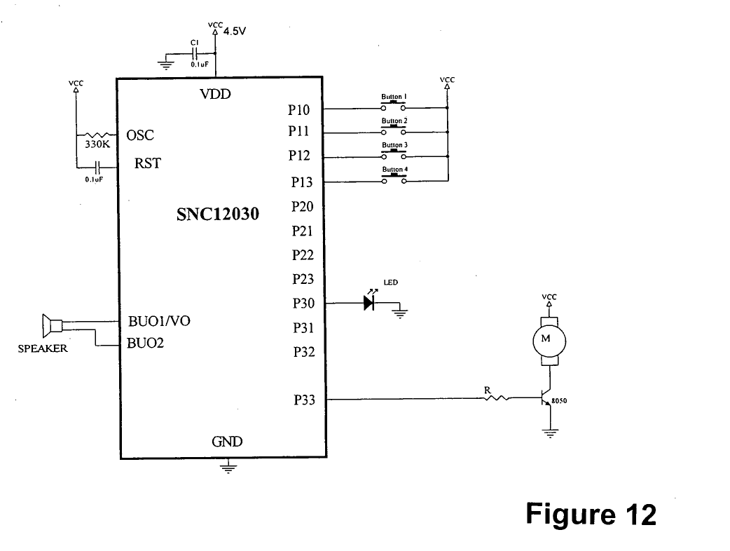

FIG. 12 is a representative circuit diagram for a sounder. The sounder 120 can be installed in the place shown in FIG. 6. Of course, any convenient location can also be selected. The sounder comprises an IC (SNC12030), a speaker, several LED bulbs, a motor and four push buttons. When this baby rider is in a rider mode, the baby can touch three push buttons. When the first button is pressed, the speaker will play surrounding noise (such as dog barks, bird chirps, people talk, etc) for 20 seconds. This simulates that this vehicle (the baby rider) is in an open air environment. When the second button is pressed, the speaker will play sound of a motor starting, and the baby rider vibrates (caused by the motor), and LED bulbs flash. This simulates the vehicle is starting and also ends in 20 seconds. When the third button is pressed, the speaker will play a sound of a horn, and the headlight will light. This action will terminate in 3 seconds. The time lines are generally desirable. Four AA size batteries will likely be exhausted in approximately 10 hours if any of the buttons are continuously pressed.

When this baby rider is in its toy mower mode, the above mentioned three buttons are untouchable. The fourth button is now touchable. When the fourth button is pressed, the speaker will play the sound of a motor for 4 seconds, followed by a song. Then the sickle will rotate (by the motor), and LED bulbs flash, for a total of 12 seconds.

We claim:

1. A transformable baby rider comprising a main body including four wheels, a hood and motor cover and a seat with a handlebar, in which, said hood and motor cover is pivoted about a pivot axis at a middle location of said main body, said seat is pivoted at a rear of said main body about a pivot axis and said handlebar is pivoted on front of said seat, said baby rider being transformable into a toy mower wherein, said seat with its handlebar is pivoted upwardly into a position which is simulating a grass collector of a mower, said handlebar is pivoted into a position which is parallel to said seat, and said hood and motor cover is pivoted into a vacancy formerly occupied by said seat for simulating an engine cover of a mower.

2. A transformable baby rider as in claim 1, further comprising locking mechanisms for keeping the handlebar, seat and hood and motor cover in their different positions.

3. A transformable baby rider as in claim 1, wherein said hood and motor cover are integrally formed.

4. A transformable baby rider as in claim 1, wherein said hood and motor cover are manufactured separately and then connected into one piece.

5. A transformable baby rider as in claim 1, and further comprising at least one additional accessory in said baby rider for aesthetically enhancing the vehicle-like appearance of said baby rider.

6. A transformable baby rider as in claim 5, wherein said at least one additional accessory includes headlights.

7. A transformable baby rider as in claim 5, wherein said at least one additional accessory includes a sounder which simulates the sound of a motor.

8. A transformable baby rider as in claim 1, further comprising wheel hubs mounted to said wheels.
